(19) United States
(12) Patent Application Publication
(10) Pub. No.: US 2006/0073935 A1
(43) Pub. Date: Apr. 6, 2006

(54) Toroidal type continuously variable transmission

(75) Inventors: Takashi Imanishi, Kanagawa (JP); Eiji Inoue, Kanagawa (JP); Hiroki Nishii, Kanagawa (JP); Shoji Yokoyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/235,202

(22) Filed: Sep. 27, 2005

(30) Foreign Application Priority Data
Sep. 27, 2004 (JP) P.2004-279362
May 17, 2005 (JP) P.2005-144783

(51) Int. Cl. F16H 15/38

(52) U.S. Cl. 476/46

(57) ABSTRACT

A toroidal type continuously variable transmission has input and output side disks arranged concentrically with a first axis, a power roller, a trunnion swung around a second axis, the trunnion including a main body portion, bent wall portions, pivot shafts and an oval hole, an outer ring contained in a pocket portion provided on the trunnion and a bearing for movably supporting the outer ring in the direction perpendicular to the second axis provided between the rain body portion and the outer ring. The outer ring includes a first shaft portion for rotatably supporting the power roller and a second shaft portion arranged concentrically with the first shaft portion and movably supported by the oval hole along a direction perpendicular to the second axis. Tangential forces generated between the power roller, the input and output side disks are supported on the second shaft portion and the trunnion.

The present invention claims foreign priority to Japanese patent applications No. P.2004-279362, filed on Sep. 27, 2004 and No. P.2005-144783, filed on May 17, 2005, the contents of which are incorporated herein by references.

### BACKGROUND OF THE INVENTION

1. Field of the Invention

The present invention relates to a toroidal type continuously variable transmission capable of being utilized in a transmission of an automobile or various industrial machines or the like.

2. Description of the Background Art

A double cavity type toroidal type continuously variable transmission used as, for example, a transmission for an automobile is constituted as shown by FIG. 17 and FIG. 18. As shown by FIG. 17, an input shaft (center shaft) 1 is rotatibly supported by an inner side of a casing 50, and an outer periphery of the input shaft 1 is attached with two input side disks 2, 2 and two of output side disks 3, 3. Further, an output gear 4 is rotatably supported by an outer periphery of a middle portion of the input shaft 1. The output side disks 3, 3 are connected to flange portions 4a, 4a in a cylindrical shape provided at a center portion of the output gear 4 by spline coupling.

The input shaft 1 is driven to rotate by a drive shaft 22 via a pressing apparatus 12 of a loading cam type provided between the input side disk 2 disposed on a left side of the drawing and a cam plate 7. Further, the output gear 4 is provided in the casing 50 via a partition wall 13 constituted by coupling two members and by the constitution, whereas the output gear 4 can be rotated around an axis (first axis) O of the input shaft 1, displacement thereof in a direction of the axis O is hampered.

The output side disks 3, 3 are rotatably supported around the axis O of the input shaft 1 by needle bearings 5, 5 interposed between the output side disks 3, 3 and the input shaft 1. Further, the input side disk 2 on the left side of the drawing is supported by the input shaft 1 via a ball spline 6. The input side disk 2 on a right side of the drawing is coupled to the input shaft 1 by a spline, and the input side disks 2 are rotated along with the input shaft 1. Further, power rollers 11 (refer to FIG. 18) are rotatably held between inner side faces (recess faces) 2a, 2a of the input side disks 2, 2 and inner side faces (recess faces) 3a, 3a of the output disks 3, 3.

A stepped difference portion 2b is provided at an inner peripheral face 2c of the input side disk 2 disposed on the right side of FIG. 17, the stepped difference portion 2b is butted with a stepped difference portion 1b provided on an outer peripheral face 1a of the input shaft 1, and a loading nut 9 is butted to a rear face (right face of FIG. 17) of the input side disk 2. By the constitution, displacement of the input side disk 2 relative to the input shaft 1 in the direction of the axis O is substantially hampered. Further, a leaf spring 8 is provided between a cam plate 7 and a flange portion 1d of the input shaft 11 and the leaf spring 8 exerts a press force to portions of the recess faces 2a, 2a, 3a, 3a of the respective disks 2, 2, 3, 3 and peripheral faces 11a, 11a of the power rollers 11, 11 brought into contact with each other.

FIG. 18 is a sectional view taken along a line A-A of FIG. 17. As shown by FIG. 18, the inner side of the casing 50 is provided with a pair of trunnions 15, 15 pivoted around a pair of pivot shafts 14, 14 (hereinafter, a center axis O′ of the pivot shaft is referred to as second axis) disposed at positions twisted to the input shaft 1. Further, in FIG. 18, illustration of the input shaft 1 is omitted. The respective trunnions 15, 15 include support plate portions 16 constituting main body portions extended substantially in parallel with the second axis O′, pairs of bent wall portions 20, 20 formed at both end portions in longitudinal directions (up and down directions of FIG. 18) of the support plate portions 16 (extended to be inclined relative to the second axis from the both end portions of the support plate portions 16, 16) and the pivoting axes 14, 14 extended to outer sides concentrically to each other along the second axis o from outer side faces of the bent wall portions 20, 20. Further, the respective trunnions 15, 15 are formed with pocket portions P in a recess shape for containing the power rollers 11 by the bent wall portions 20, 20.

Circular holes 21 are formed at center portions of the support plate portions 16 and base end portions 23a of displacement shafts 23 are supported by the circular holes 21. Further, by pivoting the respective trunnions 15, 15 around the respective pivot shafts 14, 14, inclined angles of the displacement shafts supported by the center portions of the respective trunnions 15, 15 can be adjusted. Further, the respective power rollers 11, 11 are rotatably supported by surroundings of front end portions 23b of the displacement shafts 23 projected from inner side faces of the respective trunnions, 15, 15, and the respective power rollers 11, 11 are held between the respective input side disks 2, 2 and the respective output side disks 3, 3. Further, the base end portions 23a and the front end portions 23b of the respective displacement shafts 23, 23 are eccentric to each other.

Further, the pivot shafts 14, 14 of the respective trunnions 15, 15 are supported by a pair of yokes 23A, 23B being capable of pivoting and displacing in axial directions (up and down direction of FIG. 17, up and down direction of FIG. 18), and movement of the trunnions 15, 15 in a horizontal direction is restricted by the respective yokes 23A, 23B. The respective yokes 23A, 23B are formed in a rectangular shape by pressing or forging a metal such as steel or the like. Four corners of the respective yokes 23A, 23B are provided with four support holes 18, and the pivot shafts 14 provided at the both end portions of the trunnions 15 are respectively supported by the support holes 18 pivotably via radial needle bearings 30. Further, locking holes 19 are provided at center portions in width directions (left and right direction of FIG. 18) of the yokes 23A, 23B, inner peripheral faces of the locking holes 19 are constituted by spherical recess faces and spherical posts 64, 68 are inwardly fitted thereto. That is, the yoke 23A on an upper side is pivotably supported by the spherical post 64 supported by the casing 50 via a fixing member 52, and the yoke 23A on a lower side is pivotably supported by the spherical post 68 and an upper-side cylinder body 61 of a cylinder 31 supporting the spherical post 68.

Further, the respective displacement shafts 23, 23 provided at the respective trunnions 15, 15 are provided at positions on sides opposed to each other by 180 degrees relative to the input-shaft 1. Further, directions of the front end portions 23b of the respective displacement shafts 23, 23 eccentric to the base end portions 23a are constituted by directions the same as rotational directions of the two disks 2, 2, 3, 3 (inversely in an up and down direction of FIG. 18). Further, the eccentric directions are constituted by directions substantially perpendicular to the direction of arranging the input shaft 1. Therefore, the respective power rollers 11, 11 are supported to be able to displace more or less in a longitudinal direction of the input shaft 1. As a result, even when the respective power rollers 11, 11 tend to be displaced in the axial direction of the input shaft 1 owing to elastic deformation or the like of respective constituent members based on a thrust load generated by the pressing apparatus 12, forcible forces are not exerted to the respective constituent members and the displacements are absorbed.

Further, between an outer side face of the power roller 11 and an inner side face of the support plate portion 16, a thrust ball bearing 24 constituting a thrust rolling bearing and a thrust needle bearing 25 are provided successively from bearings, the thrust ball bearings 24 permit rotation of the respective power rollers 11 while supporting loads in the thrust direction exerted to the power rollers 11. The thrust ball bearings 24 are constituted by respective pluralities of pieces of balls 26, 26, retainers 27 in a shape of a circular ring for rollably holding the respective balls 26, 26 and outer rings 28 in a shape of a circular ring. Further, inner ring tracks of the respective thrust ball bearings 24 are formed at outer side faces (large end faces) of the respective power rollers 11 and outer ring tracks thereof are formed inner side faces of the respective outer rings 28, respectively.

Further, the thrust needle bearing 25 is held between the inner side face of the support plate portion 16 of the trunnion 15 and an outer side face of the outer ring 28. The thrust needle bearings 25 permit the power rollers 11 and the outer rings 28 to swing around the base end portions 23a of the respective displacement shafts 23 while supporting thrust loads exerted to the respective outer rings 28 from the power rollers 11.

Further, respective drive rods (trunnion shafts) 29, 29 are provided at end portions on one side (lower end portions of FIG. 18) of the respective trunnions 15, 15, and drive pistons (hydraulic pistons) 33, 33 are fixedly provided at outer peripheral faces of middle portions of the respective drive rods 29, 29. Further, the respective drive pistons 33, 33 are fitted in oil tight into the drive cylinders 31 constituted by the upper side cylinder bodies 61 and lower side cylinder bodies 62. Further, drive apparatus 32 for displacing the respective trunnions 15, 15 in axial directions of the pivot shafts 14, 14 of the trunnions 15, 15 are constituted by the respective drive pistons 33, 33 and the drive cylinder 31.

In the case of the toroidal type continuously variable transmission constituted in this way, rotation of the drive shaft 22 is transmitted to the respective input side disks 2, 2 and the input shaft 1 via the pressing apparatus 12. Further, rotation of the input side disks 2, 2 is transmitted to the respective output side disks 3, 3 via the pairs of power rollers 11, 11, and rotation of the respective output side disks 3, 3 is outputted from the output gear 4.

When changing a ratio of rotational speeds between the input shaft 1 and the output gear 4, the pair of drive pistons 33, 33 are displaced in directions inverse to each other. In accordance with displacements of the respective drive pistons 33, 33, the pair of trunnions 15, 15 are displaced in directions inverse to each other. For example, the power roller 11 on the left side of FIG. 18 is displaced to a lower side of the drawing and the power roller 11 on the right side of the drawing is displaced to the upper side of the drawing, respectively. As a result, directions of the forces in tangential directions operated to the positions of the inner peripheral faces 11a, 11a of the respective power rollers 11, 11 and the inner side faces 2a, 2a, 3a, 3a of the respective input side disks 2, 2 and the respective output side disks 3, 3 brought into contact with each other are changed. Further, in accordance with changes in the directions of the forces, the respective trunnions 15, 15 are pivoted in directions inverse to each other around the pivot shafts 14, 14 axially supported by the yokes 23A, 23B.

As a result, the positions of the peripheral faces 11a, 11a of the respective power rollers 11, 11 and the respective inner side faces 2a, 3a brought into contact with each other are changed and the ratio of the rotational speeds between the input shaft 1 and the output gear 4 is changed. Further, when a torque transmitted between the input shaft 1 and the output gear 4 is varied and amounts of elastic deformation of respective constituent members are changed, the respective power rollers 11, 11 and the outer rings 28, 28 belonging to the respective power rollers 11, 11 are slightly pivoted around the base end portions 23a, 23a of the respective displacement shafts 23, 23. Since the thrust needle bearings 25, 25 are present between the outer side faces of the respective outer rings 28, 28 and the inner side faces of the support plate portions 16 constituting the respective trunnions 15, 15, the pivoting is carried out smoothly. Therefore, forces for changing the inclined angles of the respective displacement shafts 23, 23 as described above, are reduced.

Meanwhile, according to the toroidal type continuously variable transmission, power is transmitted between the power roller 11 and the input and the output side disks 2, 3 in a non-contact state by a traction force via an oil film in order to prevent damage of surfaces of the members (interfaces between the power roller 11 and the input and the output side disks 2, 3 formed by oil films are referred to as traction faces) Therefore, it is necessary to supply a lubricant (traction oil) by an amount sufficient for enabling to form the oil films for transmitting the torque in non-contact state to the traction faces formed between the power roller 11 and the input and the output side disks 2, 3.

Further, according to the toroidal type continuously variable transmission, the base end portion 23a and the front end portion 23b of the displacement shaft 23 are eccentric to each other and therefore, there poses a problem that working thereof is difficult, part cost is increased, and the trunnion 15 is large-sized and heavy-weighted in order to ensure a support rigidity. Hence, for example, in Japanese Patent Unexamined Publications Nos. JP-A-2001-12574, JP-A-2002-235826, JP-A-2003-294099, JP-A-2004-138249 and JP-A-2004-169785, there is disclosed a support mechanism of a linear motion type for adjusting positions of the power roller 11 relative to the two disks 2, 3, by supporting the power roller 11 relative to the trunnion 15 movably in parallel with a direction perpendicular to the pivoting axis or (supporting sliding movement of the power roller 11 in the axial direction of the disk).

According thereto, as shown by FIG. 19, there are constituted a pair of linear motion bearings 218 by forming a pair of inclined faces 215a, 215a inclinations of which are directed inversely to each other in a longitudinal direction of the trunnion 15 at faces of the trunnion 15 on a side of the pocket P containing the power roller 11, on the other hand, forming a pair of inclined faces 215b, 215b in parallel with the inclined faces 215a, 215a also at a rear face of the outer ring 28 rotatably supporting the power roller 11, and arranging rolling members (rollers) 217 between the inclined faces opposed to each other (that is, arranging the rolling members 217 between the bent wall portion 20 of the trunnion 15 and the outer ring 28). By the constitution, the power roller 11 is made to be movable in a width direction (direction perpendicular to paper face) of the trunnion 15, and positional shifts between the power roller 11 and the two disks 2, 3 in accordance with relative displacements of constituent parts and elastic deformation of parts in accordance with inclining to roll the trunnion 15 are adjusted. Further, by the pair of linear motion bearings 218 inclined in directions inverse to each other, both of forces operated in the thrust direction (up and down direction of the drawing) loaded from the input side and the output side disks 2, 3 to the power roller 11 and in the longitudinal direction of the trunnion 15 (left and right direction of the drawing) can be received.

The linear motion bearing 218 holds not only the thrust force produced at the power roller 11 but also the traction force. The traction force is operated to shift the power roller 11 in a direction of the inclined shaft (pivot shaft) 14 and when the shift is produced, the power roller 11 is shifted from the center shaft, side slip is brought about to pose a problem that a set speed change ratio is shifted (this is generally referred to as torque shift). As a result, there is a concern that not only a speed change control becomes difficult but also an adverse influence is effected on maneuverability, however, according to the apparatus provided with the linear motion bearing 218, there is not a clearance of the bearing in contrast to a pivot shaft (displacement shaft 23) type of the background art and therefore, the apparatus is advantageous for the torque shift.

However, according to the power roller unit of the linear motion bearing type, as shown by FIG. 19, in order to support a tangential force exerted to the contact portion of the power roller 11 by a traction power, there is provided an intersecting angle to the two linear motion bearings 218, 218 (the two linear motion bearings 218, 218 are arranged on inclined faces inclined in directions inverse to each other). Therefore, there pose a number of problems as follows.

That is, when the intersecting angle is provided to the two linear motion bearings 218k, 218 in this way, unless accuracy of the angle is made to be severe, the linear motion bearings 218, 218 are not correctly brought into contact with track faces and therefore, a working step for promoting the accuracy of the angle becomes complicated and cost is increased. Further, the power roller 11 is operated with the large thrust load and there also is a case in which the trunnion 15 is elastically deformed by the thrust load and the intersecting angle cannot be maintained correctly by the elastic deformation. Further, when the tangential force is exerted, as shown by FIG. 20, a moment M is generated, and there is a concern that the power roller 11 per se is inclined (falls), the power roller 11 is shifted from the center axis and the torque shift is brought about.

Further, although the JP-A-2001-12574 discloses a structure in which the intersecting angle is not provided to the two linear motion bearings, by only the structure in which the intersecting angle is not provided to the linear motion bearings, when upper and lower portions of the power roller is considerably deformed in elastically deforming the trunnion, an influence of the elastic deformation is liable to be effected to the linear motion bearing.

### SUMMARY OF THE INVENTION

The present invention has been carried out in view of the above-described situation and it is an object thereof to provide a toroidal type continuously variable transmission which can support sliding movement of a power roller in an axial direction of a disk and in which a support structure thereof is difficult to be effected with an influence of an elastic deformation of a trunnion without complicating working steps.

In order to achieve the above-described object, according to a first aspect of the present invention, there in provided a toroidal type continuously variable transmission comprising:

an input side disk and an output side disk arranged concentrically with a first axis and opposed to each other;

a power roller held between the input and output side disks;

a trunnion disposed so as to swing around a second axis which is twisted to the first axis; and

an outer ring contained in a pocket portion provided at a center portion of the trunnion in a direction of the second axis,

wherein the trunnion includes:

a main body portion extended substantially in parallel with the second axis;

a pair of bent wall portions extended from both end portions of the main body portion;

pivot shafts extended to outer sides from both of the bent wall portions along with the second axis; and

an oval hole, of which longitudinal axis extends in a direction perpendicular to the second axis, formed on a center portion of the main body portion in a direction of the second axis,

wherein a bearing for movably supporting the outer ring in the direction perpendicular to the second axis is provided between the main body portion of the trunnion and the outer ring,

wherein the outer ring includes:

a first shaft portion for rotatably supporting the power roller; and

a second shaft portion arranged substantially concentrically with the first shaft portion and movably supported by the oval hole of the trunnion along a direction perpendicular to the second axis, and

wherein tangential forces generated between the power roller and both of the input and output side disks are supported on both of the second shaft portion and the trunnion.

According to the first aspect of the present invention, the bearing for movably supporting the outer ring in the direction perpendicular to the second axis is provided between the main body portion of the trunnion extended substantially in parallel with the second axis and the outer ring and therefore. Thus, it is not necessary to provide an intersection angle to the bearing. Therefore, working steps of the trunnion can be simplified, as a result, fabrication cost can be reduced. Further, the second shaft portion extended from the outer ring is supported by the oval hole of the trunnion movably along the direction perpendicular to the second axis, the tangential forces produced between the power roller and both of the input and output side disks are supported between the second shaft portion and the trunnion. Therefore, the bearing is difficult to be effected with an influence of elastic deformation of the trunnion. Further, since a pivot shaft (displacement shaft) as in the background art is not used, machining of the outer ring is simplified, and also, the power roller is not moved in the axial direction of the trunnion relative to movement of the power roller in an axial direction of the disk and a torque shift caused thereby can be alleviated.

According to a second aspect of the present invention, as set forth in the first aspect of the present invention, it is preferable that the bearing is a thrust needle bearing in a shape of a circular ring, and

the bearing is formed substantially concentrically with a surrounding of the oval hole for supporting a force in a thrust direction.

According to a third aspect of the present invention, there is provided a toroidal type continuously variable transmission, comprising:

an input side disk and an output side disk arranged concentrically with a first axis and opposed to each other;

a power roller held between the input and output side disks;

a trunnion disposed so as to swing around a second axis which is twisted to the first axis; and

an outer ring contained in a pocket portion provided at a center portion of the trunnion in a direction of the second axis,

wherein the trunnion includes:

a main body portion extended substantially in parallel with the second axis;

a pair of bent wall portions extended from both end portions of the main body portion;

pivot shafts extended to outer sides from the bent wall portions along with the second axis; and

an oval hole, of which longitudinal axis extends in a direction perpendicular to the second axis, formed on a center portion of the main body portion in a direction of the second axis,

wherein a bearing for movably supporting the outer ring in the direction perpendicular to the second axis is provided between the main body portion of the trunnion and the outer ring,

wherein the outer ring includes:

a first shaft portion for rotatably supporting the power roller; and

a second shaft portion arranged substantially concentrically with the first shaft portion and supported by the oval hole of the trunnion movably via a radial bearing along a direction perpendicular to the second axis, and

wherein tangential forces generated between the power roller and both of the input and output side the disks are supported on the second shaft portion, the radial bearing and the trunnion.

According to the third aspect of the present invention, the bearing for movably supporting the outer ring in the direction perpendicular to the second axis is provided between the main body portion of the trunnion extended substantially in parallel with the second axis and the outer ring. Accordingly, it is not necessary to provide an intersecting angle to the bearing. Therefore, working steps of the trunnion can be simplified, as a result, fabrication cost can be reduced. Further, the second shaft extended from the outer ring is supported by the oval hole of the trunnion movably along the direction perpendicular to the second axis via the radial bearing, the tangential forces produced between the power roller and the two disks are supported between the second shaft portion and the radial bearing and the trunnion. Therefore, the bearing is difficult to be effected with the influence of the elastic deformation of the trunnion. Further, since a pivot shaft (displacement shaft) as in the background art is not used, machining of the outer ring is simplified, and also, the power roller is not moved in the axial direction of the trunnion relative to movement of the power roller in the axial direction of the disk and a torque shift caused thereby can be alleviated.

According to a fourth aspect of the present invention, as set forth in the third aspect of the present invention, it is preferable that the bearing comprises:

a pair of thrust needle bearings supporting a force in a thrust direction and extended linearly along the direction perpendicular to the second axis,

wherein and the thrust needle bearings is opposed to each other across the oval hole.

According to fifth and sixth aspects of the present invention, as set forth in the first and third aspects of the present invention, it is preferable that the toroidal type continuously variable transmission further comprising:

an substantially ring-like oil guide member provided between the main body portion of the trunnion and the outer ring and the oil guide member provided on an inner side of the bearing so as to surround the oval hole,

wherein a first oil groove is formed on a face of the oil guide member which abuts with the outer ring,

the first oil groove communicates with a trunnion side oil path for a lubricant formed on the trunnion and is ring shape which is concentric with the oval hole, and

wherein a second oil groove is formed on a face of the outer ring which abuts with the oil guide member,

the second oil groove opposes to the first oil groove and communicates with an outer ring side oil path for lubricant formed on the outer ring,

the second oil groove of which diameter is substantially the same as that of the first oil groove and is arranged concentric with the second shaft portion.

According to the fifth and sixth aspects of the present invention, the oil guide member is provided between the main body portion of the trunnion and the outer ring, the face of the oil guide member brought into contact with the outer ring is provided with the first oil groove in the shape of the circular ring communicated with the oil path of the lubricant provided at the trunnion and substantially around the oval hole, the face of the outer ring brought into contact with the oil guide member is formed with the second oil groove in the shape of the circular ring opposed to the first oil groove and communicated with the oil path of the lubricant provided at the outer ring, having the diameter substantially the same as the diameter of the first oil groove and substantially around the second shaft and therefore, the lubricant can be supplied to the oil path of the outer ring from the oil path of the trunnion via the oil guide member while preventing the lubricant from being leaked to other place.

That is, the lubricant is moved between the first oil groove and the second oil groove respectively provided at the faces of the oil guide member and the outer ring brought into contact with each other and therefore, leakage of the lubricant from the two faces brought into contact with each other can be prevented. Particularly, when the oval hole is a through hole, oil leakage from the oval hole can be prevented, when the bearing is a pair of thrust needle bearings in a linear shaper oil leakage from a clearance produced between the pair of thrust needle bearings and between the main body portion of the trunnion and the outer ring can be prevented.

Further, the faces of the oil guide member and the outer ring brought into contact with each other are formed with the first oil groove and the second oil groove in the shape of the circular ring substantially having the same diameter respectively. Therefore, even when the outer ring is slightly moved in the direction perpendicular to the second axis, so far as the first oil groove and the second oil groove are not moved by an amount larger than the diameters, the first oil groove and the second oil groove are brought into a state of being overlapped each other at least partially and a state of capable of moving the lubricant between the first oil groove and the second oil groove can be maintained.

Further, regarding the trunnion side, it is not necessary to fabricate particularly other than enabling to attach the oil guide member and even when a structure for preventing oil leakage as described above is added, the trunnion can be formed inexpensively.

Further, when the oil guide member arranged on the inner side of the bearing is attached to the trunnion prior to the bearing, the oil guide member can be utilized as a member of guiding to position attachment of the bearing in attaching the bearing. Further, when a structure of enabling to position the bearing is constituted by the oil guide member, in assembling, the oil guide member can be used as a portion of a member for restricting movement of the bearing, or a reinforcement of a member for restricting movement of the bearing when the bearing is used. Thereby, a structure of guiding and positioning to attach the bearing in attaching the bearing can be omitted in the trunnion. In addition thereto, a portion of a member for restricting movement of the bearing can be omitted, further, a member or restricting movement of the bearing can be simplified and a reduction in cost of the trunnion can be achieved.

Here, when the bearing is a thrust needle bearing in a shape of a circular ring, the oil guide member is arranged on an inner side of an inner periphery of the thrust needle in the shape of the circular ring at the inner side of the bearing and therefore, guiding and positioning in attaching the thrust needle bearing and restricting movement of the thrust needle bearing can be carried out by an outer periphery of the oil guide member.

Further, when the bearing is constituted by a pair of thrust needle bearings in a linear shape, the oil guide member is arranged between the pair of thrust needle bearings in the linear shape as the inner side of the bearing and therefore, at outer peripheral portions at two locations of the oil guide member constituting sides opposed to each other, guiding and positioning of attachment of the thrust needle bearing and restricting movement of the thrust needle bearing can be carried out.

In the above-described respective aspects of the present invention, the second shaft portion may integrally be formed with the outer ring, or may be formed separately from the outer ring to be attached to the outer ring. Further, the oval hole formed at the trunnion may be a through hole or a closed hole in which a bottom portion thereof is closed. When the oval hole is constituted by the closed hole, stress concentration is not brought about at a surrounding of the hole when a large torque is transmitted particularly as in a large sized vehicle or the like and therefore, the closed hole is advantageous.

According to the toroidal type continuously variable transmission of the invention, sliding movement of the power roller in the axial direction of the disk can be supported without complicating the working steps and the supporting structure is difficult to be effected with an influence of elastic deformation of the trunnion. Further, according to the toroidal type continuously variable transmission of the invention, a reduction in cost of the trunnion is achieved and the lubricant can be supplied from the oil path of the trunnion to the oil path of the outer ring while preventing leakage to other place.

### BRIEF DESCRIPTION OF THE DRAWINGS

FIG. 1A is a disassembled perspective view showing an essential portion of a toroidal type continuously variable transmission according to a first embodiment of the invention;

FIG. 1B is a perspective view constituting a halved section of FIG. 1A;

FIG. 2 is a disassembled perspective view of an essential portion of a toroidal type continuously variable transmission according to a second embodiment of the invention;

FIG. 3 is a perspective view of an essential portion showing a toroidal type continuously variable transmission according to a third embodiment of the invention;

FIG. 4 is a disassembled perspective view of an essential portion showing the toroidal type continuously variable transmission according to the third embodiment;

FIG. 5 is a front view of a trunnion in a state of attaching an outer ring of the toroidal type continuously variable transmission according to the third embodiment;

FIG. 6 is a partially broken side view of the trunnion in the state of attaching the outer ring of the toroidal type continuously variable transmission according to the third embodiment;

FIG. 7 is a sectional view taken along a line B-B of FIG. 5;

FIG. 8 is a view for explaining a relationship between a first oil groove and a second oil groove of the toroidal type continuously variable transmission according to the third embodiment;

FIG. 9 is a disassembled perspective view of an essential portion showing a toroidal type continuously variable transmission according to a fourth embodiment of the invention;

FIG. 10 is a disassembled perspective view of an essential portion showing the toroidal type continuously variable transmission according to the fourth embodiment;

FIG. 11 is a front view of a trunnion in a state of attaching an outer ring of the toroidal type continuously variable transmission according to the fourth embodiment;

FIG. 12 is a partially broken side view of a trunnion in the state of attaching the outer ring of the toroidal type continuously variable transmission according to the fourth embodiment;

FIG. 13 is a sectional view taken along a line C-C of FIG. 11;

FIG. 14 is a view for explaining a relationship between a first oil groove and a second oil groove in the toroidal type continuously variable transmission according to the fourth embodiment;

FIG. 15 is a disassembled perspective view of an essential portion showing a toroidal type continuously variable transmission according to a modified example of the second embodiment;

FIG. 16 is a disassembled perspective view of an essential portion showing a toroidal type continuously variable transmission according to a modified example of the second embodiment;

FIG. 17 is a sectional view showing an example of a specific structure of a toroidal type continuously variable transmission known in a background art;

FIG. 18 is a sectional view taken along a line A-A of FIG. 17;

FIG. 19 is a sectional view of an essential portion a toroidal type continuously variable transmission having a linear motion bearing;

FIG. 20 is a sectional view of an essential portion showing a state of producing a torque shift in a constitution of FIG. 19.

### DETAILED DESCRIPTION OF THE PREFERRED EMBODIMENTS

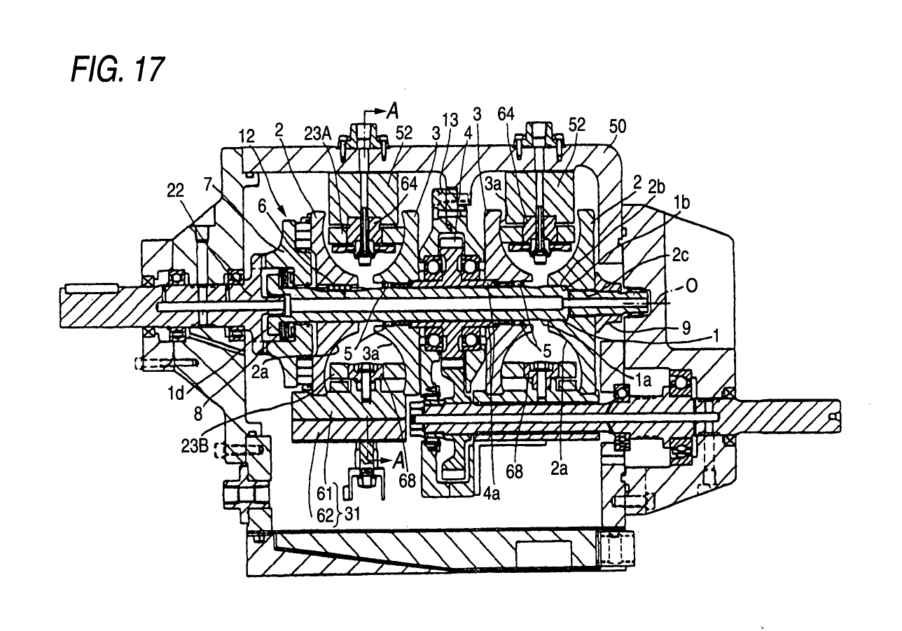

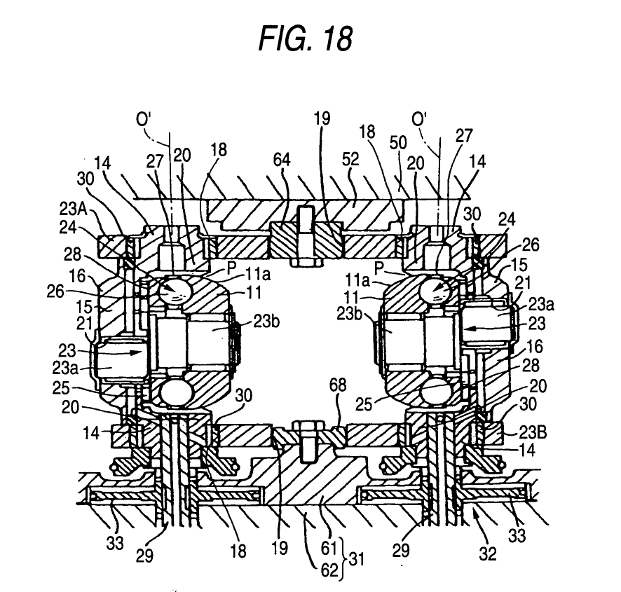

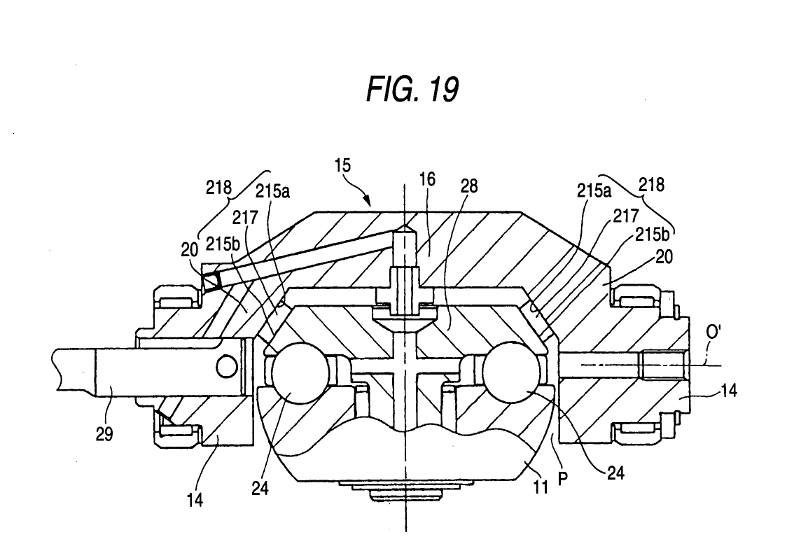

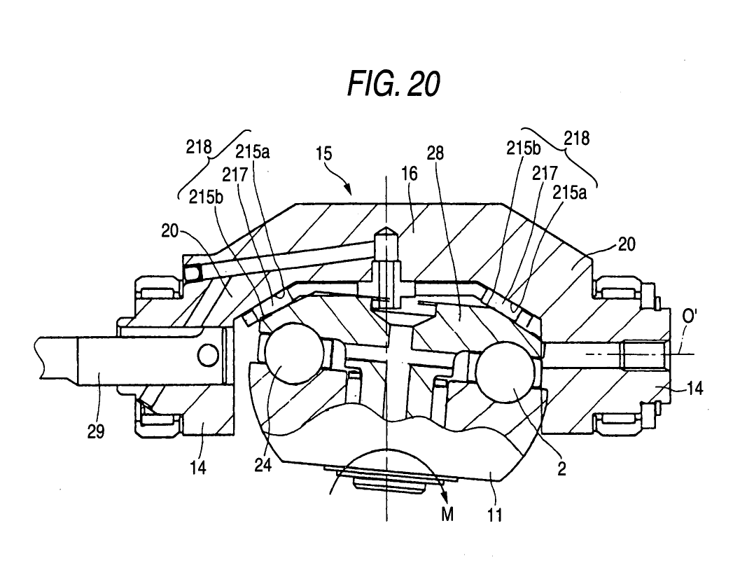

A first embodiment of the invention will be explained in reference to the drawings as follows. Characteristic points of the invention reside in a supporting structure for movably supporting an outer ring in a direction perpendicular to a pivot shaft of a trunnion, that is, the second axis. The other points such as the constitution and operation are similar to the constitution and the operation of the background art Therefore, in the following, only characteristic points of the present invention will be referred and other points are attached with notations the same as those of FIG. 17 through FIG. 20 and a concise explanation will be given thereto.

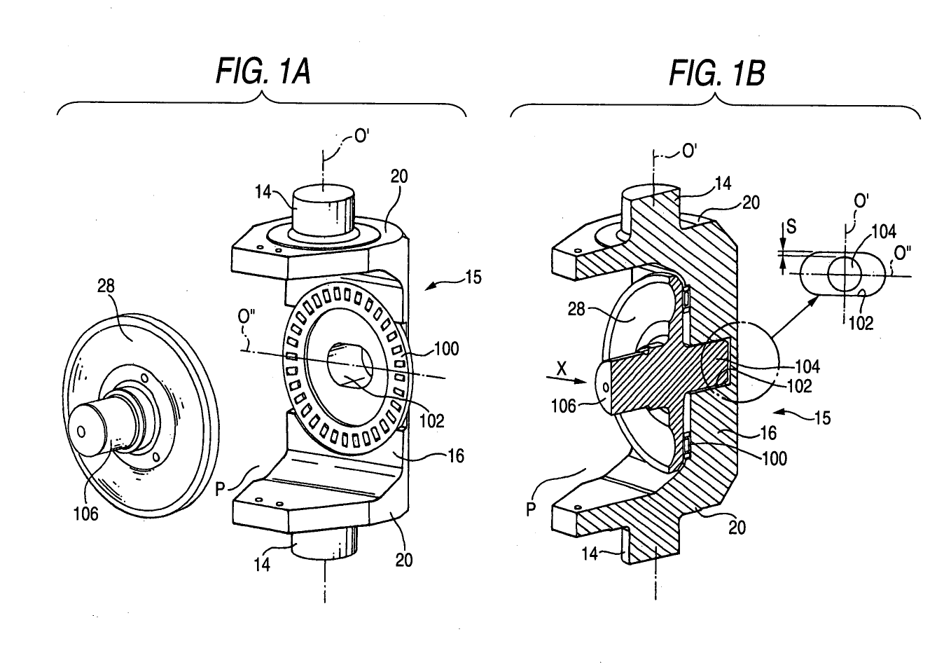

FIGS. 1A and 1B show a first embodiment of the invention. As illustrated, according to the embodiment, the trunnion 15 comprises the support plate portion 16 as the main body portion extended substantially in parallel with the second axis O′, the bent wall portions 20 extended to be inclined to the second axis O′ from the both end portions of the support plate portion 16, and the pivot shaft 14 extended to the outer side along the second axis O′ from the bent wall portion 20. Further, an oval hole 102 of which longitudinal axis is extended in a direction O″ perpendicular to the second axis O′ is formed substantially at a center portion in the longitudinal direction (second axis direction) of the support plate portion 16. Although in the case of the embodiment, the oval hole 102 is formed as a closed hole in which a bottom portion thereof is closed, the oval hole 102 may be a through hole penetrating the support plate portion 16.

Between the support plate portion 16 of the trunnion 15 and the outer ring 28, there is provided a bearing 100 for supporting the outer ring 28 movably in the direction o perpendicular to the second axis O′. The bearing 100 is formed as a thrust needle bearing in a shape of a circular ring constituting a rolling track thereof by an inner face (face on a aide of being opposed to the outer ring 18) of the support plate portion 16, arranged substantially concentrically at a surrounding of the oval hole 102 and supporting a force in a thrust direction.

The outer ring 28 arranged in the pocket P of the trunnion 15 includes a first shaft portion 106 for rotatably supporting the power roller 11 on one side of a face thereof and includes a second shaft portion 104 arranged substantially concentrically with the first shaft portion 106 on other side of a face thereof. In this case, the second shaft portion 104 is supported by the oval hole 102 movably along the, direction O″ perpendicular to the second axis O′. Further, a small clearance S (equal to or smaller than, for example, 50 μm) is provided between the oval hole 102 and the second shaft portion 104. Further, the first shaft portion 106 and the second shaft portion 104 may integrally be formed with the outer ring 28, or may be formed separately from the outer ring 28 to be attached to the outer ring 28.

According to the above-described constitution, the tangential forces produced between the power roller 11 and the disks 2, 3 are supported between the second shaft portion 104 and the trunnion 15. When the power roller 11 is moved in the disk axis direction X, the second shaft portion 104 is rolled while rotating the outer ring 28 per se. Therefore, friction is reduced. Further, although when the power roller 11 is moved in the disk axis direction X, a center of rolling movement of the outer ring 28 and a center of the thrust needle bearing 100 are slightly displaced from each other, an amount of the displacement is small and therefore, the displacement does not pose a problem.

In this way, according to the embodiment, the bearing 100 for supporting the outer ring 28 movably in the direction O″ perpendicular to the second axis O′ is provided between the support plate portion 16 of the trunnion 15 extended substantially in parallel with the second axis O′ and the outer ring 28. Therefore, it is not necessary to provide the intersecting angle to the bearing 100. Therefore, the working steps of the trunnion 15 can be simplified and fabrication cost can be reduced. Further, according to the embodiment, the second shaft 104 extended from the outer ring 28 is supported by the oval hole 102 of the trunnion 15 movably along the direction O″ perpendicular to the second axis O′ and the tangential forces produced between the power roller 11 and the disks 2, 3 are supported between the second shaft portion 104 and the trunnion 15. Therefore, the bearing 100 is difficult to be effected with the influence of the elastic deformation of the trunnion 15. Further, in the case of the embodiment, the pivot shaft (displacement shaft) as in the background art is not used and therefore, fabrication of the outer ring 28 is simplified, there is not the movement in the trunnion axis direction of the power roller 11 relative to movement of the power roller 11 in the disk axis line X and the torque shaft caused thereby can be alleviated.

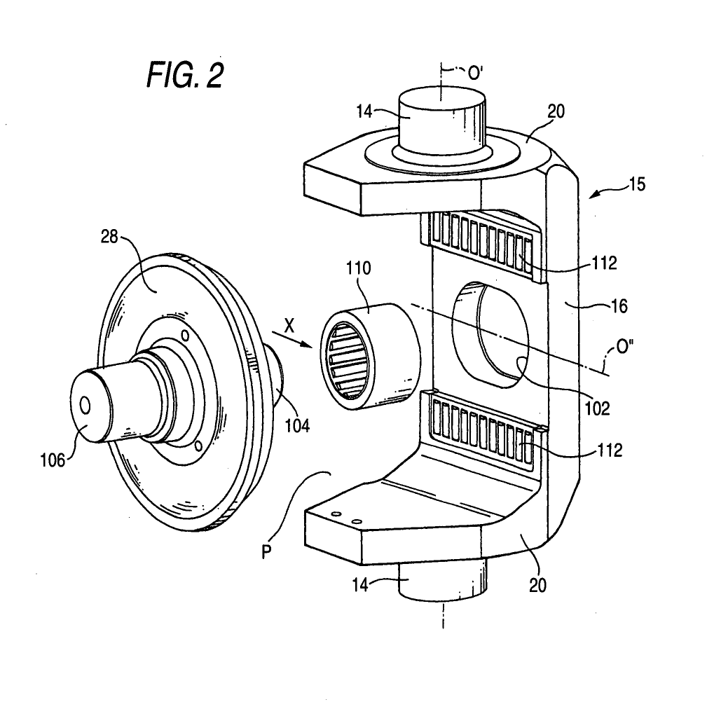

FIG. 2 shows a second embodiment of the invention. According to the embodiment, between the support plate portion 16 of the trunnion 15 and the outer ring 28, there are provided a pair of bearings 112, 112 for supporting the outer ring 28 movably in the direction O″ perpendicular to the second axis O′. The bearings 112, 112 are formed as thrust needle bearings supporting the force in the thrust direction and extended linearly along the direction O″ perpendicular to the second axis direction O′ on both sides of the oval hole 102 formed at the trunnion 15.

Further, a radial needle bearing (radial bearing) 110 in a shape of a circular ring for supporting a force in a radial direction is interposed between the second shaft portion 104 provided at the outer ring 28 and the oval hole 102. In this case, a small clearance (equal to or smaller, for example, 50 μm) is provided between the oval hole 102 and the radial needle bearing 110. Further, other constitution is the same as that of the first embodiment.

According to the above-described constitution, the tangential forces produced between the power roller 11 and the disks 2, 3 are supported among the second shaft portion 104 and the radial needle bearing 110 and the trunnion 15 and therefore, operation and effect similar to those of the first embodiment can be achieved. Further, although in the case of the embodiment, when the power roller 11 is moved in the disk axis direction X, the radial needle bearing 110 is rotated in the oval hole 102, the outer ring 28 per se is horizontally moved without bearing rotated.

An explanation will be given of a lubricant supply structure for supplying a lubricant to the bearing of the power roller 11 (for example, the thrust ball bearing 24) from an oil path of the lubricant of the trunnion 15 via an oil path of the lubricant of the outer ring 28 in the toroidal type continuously variable transmission of the first and the second embodiments.

Here, in the toroidal type continuously variable transmission shown in FIG. 1A, FIG. 1B and FIG. 2, the lubricant supply structure is omitted and in the case in which the lubricant is supplied to the bearing of the power roller from the oil path of the lubricant of the trunnion 15 via the oil path of the lubricant of the outer ring 28 in the states as shown in FIG. 1A, FIG. 1B and FIG. 2, when the oval hole 102 is constituted by the through hole, there is a possibility of leaking the lubricant from the oval hole 102 and a structure of preventing leakage of the lubricant is needed.

Further, there is needed a structure capable of supporting the lubricant from the support plate portion 16 to the outer ring 20 even when the outer ring 28 is moved in the direction O″ perpendicular to the second axis O′ relative to the support plate portion 16 of the trunnion 15.

Further, in the case of the toroidal type continuously variable transmission shown in FIG. 2, there is produced a clearance between the pair of linear thrust needle bearings (bearings 112, 112) and between the rear face of the outer ring 28 and the inner side face of the support plate portion 16 of the trunnion 15, there is a possibility of leaking the lubricant from the clearance and a structure for preventing leakage of the lubricant is needed.

Further, in FIG. 2, members for restricting movement of the bearings 112, 112 in directions of an inner side (side of the oval hole 102) are not illustrated and in attaching or using the bearings 112, 112, a structure of restricting movement of the bearings 112, 112 to the inner side is needed.

When the above-described structures of preventing leakage of the lubricant and the like are simply provided to the trunnion 15, the structure of the trunnion 15 is complicated and there is a possibility of considerably increasing the fabrication cost of the trunnion 15. Hence, an explanation will be given of the toroidal type continuously variable transmission of the invention capable of realizing the structures of preventing oil leakage and the like without increasing the fabrication cost of the trunnion 15 by a third and a fourth embodiment as follows.

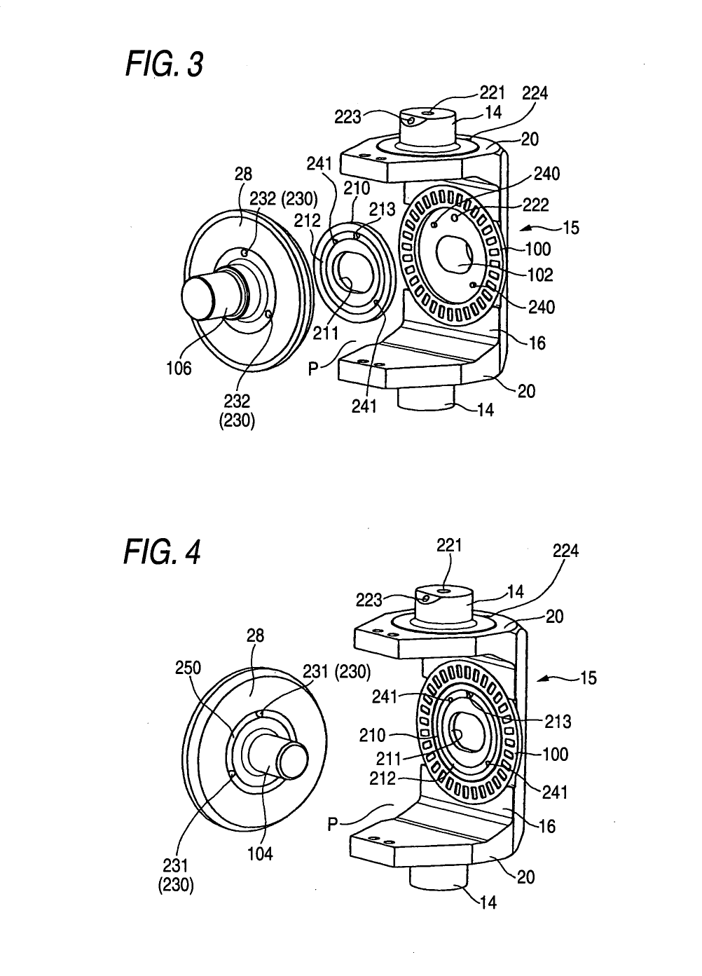

FIG. 3 through FIG. 8 show a third embodiment of the invention. Further, a toroidal type continuously variable transmission of the third embodiment is constituted by adding a lubricant supply structure for supplying the lubricant to the thrust wall bearing 24 of the power roller 11 to the toroidal type continuously variable transmission of the first embodiment shown in FIG. 1A, FIG. 1B and in the following, only the lubricant supply structure as a characteristic portion of the invention will be referred to and other portions are attached with notations the same as those of FIG. 1A, FIG. 1B and a concise explanation will be given thereto.

Here, as shown by FIG. 6, the trunnion 15 is formed with an oil path 220 of the lubricant having a flow inlet 221 at an end face of the pivot shaft 14 on one side. Further, the oil path 220 is a space (hole) in a tubular shape having a section in a circular shape, and includes a plurality of flow outlets 222, 223, 224, the flow outlet 222 there among is opened to the inner side face of the support plate portion 16 opposed to the rear face of the outer ring 28 and is connected to flow inlets 231, . . . of three oil paths 230, . . . of the lubricant, mentioned later, formed at the outer ring 28 via an oil guide member 210, mentioned later.

According to the third embodiment, the oil guide member 210 is provided between the support plate portion 16 constituting the main body portion of the trunnion 15 and the outer ring 28. The oil guide member 210 is a member for guiding (introducing) the lubricant from the flow outlet 222 of the oil path 220 of the trunnion 15 to the flow inlet 231 of the oil path 230 of the outer ring 28.

As shown by FIG. 3, the oil guide member 210 is formed in a shape of a circular plate, a center portion thereof is formed with an oval hole 211 having a shape substantially the same as the oval hole 102 formed at the support plate portion 16 and is constituted by a shape of a circular ring. Further, in this example, the oval hole 102 of the support plate portion 16 is constituted by a through hole.

Further, as shown by FIG. 4, the oil guide member 210 is attached to an inner side face of the support plate portion 16 of the trunnion 15 opposed to the rear face of the outer ring 28 and is arranged on an inner peripheral side of a thrust needle bearing in a shape of a circular ring which is the bearing 100 attached to the inner side face, further, arranged substantially concentrically at a surrounding of the oval hole 102 and supporting a force in the thrust direction.

Further, the oil guide member 210 is constituted by a size to be just brought into an inner periphery of the bearing 100 and an outer diameter of the oil guide member 210 is made to be substantially equal to an inner diameter of the bearing 100. Further, a center of the oval hole 211 is constituted substantially by a center of the oil guide member 210 in the shape of the circular plate.

Further, a rear face of the oil guide member 210 is formed in a plane shape brought into contact with the inner side face of the support plate portion 16 in a plane shape.

Further, when the oil guide member 210 is attached to the inner side of the bearing 100 at the inner side face of the support plate portion 16, the oval hole 211 and the oval hole 102 of the support plate portion 16 overlap each other, and the second shaft portion 104 of the outer ring 28 is made to penetrate through the oval hole 211 of the oil guide member 210 movably along the longitudinal direction of the oval hole 102.

Therefore, the oil guide member 210 in the ring-like shape is provided to surround the oval hole 102 on the inner side of the bearing 100.

Further, a front face of the oil guide member 210 is formed in a plane shape brought into contact with the rear face in a plane shape of the outer ring 28 and is formed with a first oil groove 212 in a shape of a circular ring constituting a center thereof substantially by the center of the oval hole 211.

The first oil groove 212 is for guiding the lubricant to the flow inlet 231 of the oil path 230 of the outer ring 28 as mentioned later and is a groove having a section in a semicircular shape and is formed to surround a periphery of the oval hole 211.

Further, the first oil groove 212 of the oil guide member 210 is arranged at a position overlapping the flow outlet 222 formed at the inner side face of the support plate portion 16 when the oil guide member 210 is attached to the support plate portion 16. Further, as shown by FIG. 6, the first oil groove 212 of the oil guide member 210 is formed with a through hole 213 constituting an oil path of the lubricant at a position of overlapping the flow outlet 222 of the inner side face of the support plate portion 16.

Further, by bringing the rear face of the oil guide member 210 and the inner side face of the support plate portion 16 into contact with each other, there is brought about a state of closing a surrounding of a portion at which the through hole 213 and the flow outlet 222 are communicated with each other, the lubricant flows out from the flow outlet 222 to the through hole 213 and the lubricant flows into the first oil groove 212 of the through hole 213. That is, a face of the oil guide member 210 brought into contact with the outer ring 28 is formed with the first oil groove 212 in the shape of the circular ring communicated to the oil path 220 of the lubricant provided at the trunnion 15 and constituting a center thereof substantially by the oval hole. Further, the flow outlet 222 of the oil path 220 of the trunnion 15 is arranged at a position overlapping the first oil groove 212 of the oil guide member 210 and overlapping the through hole 213.

Further, as shown by FIG. 3, the inner side face of the support plate portion 16 of the trunnion 15 is formed with two positioning pins 240, 240 for positioning the oil guide member 210, and the oil guide member 210 is formed with positioning holes 241, 241 to be inserted with the positioning pins 240, 240. Further, positions of the positioning pins 240, 240 and the positioning holes 241, 241 are constituted by positions of overlapping the first oil groove 212 and arranged on one diameter of the oil guide member 210 (first oil groove 212). That is, the positions of the positioning pins 240, 240 and the positioning holes 241, 241 are arranged at positions remote from each other by 180 degrees relative to a center of the oval hole 211.

Further, in a state of positioning the oil guide member 210 by inserting the positioning pins 240, 240 to the positioning holes 241, 241, the oval hole 211 and the oval hole 102 having substantially the same shape are overlapped and the through hole 213 and the flow outlet 222 are overlapped.

Further, in assembling, when prior to the bearing 100, the oil guide member 210 is positioned as described above, and attached to the trunnion 15, in attaching the bearing 100 to the trunnion 15, attachment of the bearing 100 can be guided by the oil guide member 210, and the oil guide member 210 can constitute a portion of a member positioning the bearing 100, holding the bearing 100 such that the bearing 100 is not moved in attaching the bearing 100 and restricting movement of the bearing 100 when the bearing 100 is used. Thereby, cost of fabricating the trunnion 15 can be reduced by omitting a portion of a guide member for the bearing formed at a surrounding of the bearing 100 in the shape of the circular disk of the support plate portion 16.

As shown by FIG. 4 and FIG. 6 and FIG. 7, a rear face of the outer ring 28 opposed to the inner side face of the support plate portion 16 is brought into contact with a front face of the oil guide member 210, the rear face of the outer ring 28 brought into contact with the front face of the oil guide member 210 is formed with a second oil groove 250 in a shape of a circular ring opposed to the first oil groove 212 and communicated with the oil path 230 of the lubricant provided at the outer ring 28, and having a diameter substantially the same as that of the first oil groove 212 substantially around the second shaft portion 104. Further, the second oil groove 250 is formed in a semicircular shape in a section thereof.

Further, when the second shaft portion 104 is disposed at the center of the oval hole 102 of the support plate portion 16, the first oil groove 212 at the front face of the oil guide member 210 and the second oil groove 250 at the rear face of the outer ring 28 overlap each other substantially completely. A space in a shape of a circular ring and in a tubular shape is formed by combining the first oil groove 212 and the second oil groove 250 overlapping each other in a state of closing a surrounding thereof by the front face of the oil guide member 210 and the rear face of the outer ring 28 brought into contact with each other, and the lubricant flows in from the through hole 213 into the space.

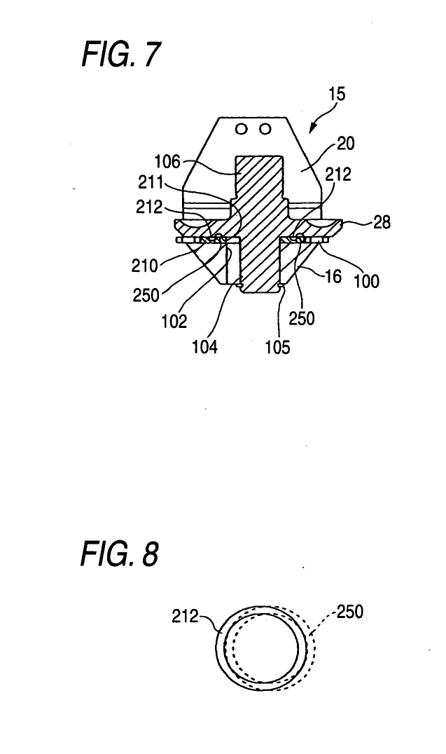

Further, as shown by FIG. 7 and FIG. 8, when the second shaft portion 104 is shifted from the center of the oval hole 102 of the support plate portion 16, that is, when the outer ring 28 is moved in a direction perpendicular to the second axis, as shown by FIG. 8, even when the first oil groove 212 and the second oil groove 250 are shifted from each other from a substantially overlapped state, there is brought about a state in which portions of the first oil groove 212 and the second oil groove 250 are necessarily overlapped to each other. Therefore, a state in which the lubricant can flow from the first oil groove 212 to the second oil groove 250 is held.

Further, as shown by FIG. 7, a portion of the oil groove 212 which does not overlap the second oil groove 250 is brought into a state of being closed by the rear face of the outer ring 28, a portion of the second oil groove 250 which does not overlap the first oil groove 212 is brought into a state of being closed by the front face of the oil guide member 210, and even when the outer ring 28 is moved, leakage of oil can be prevented.

Further, the outer ring 28 is provided with three of the respective flow inlets 231 of the three oil paths 230, . . . of the outer ring 28 at positions of the second oil groove 250. Further, the flow inlets 231, . . . are provided substantially at equal intervals along a peripheral direction of the second oil groove 250. That is, the flow inlets 231, . . . are arranged substantially at intervals of 120 degrees relative to the center of the second oil groove 250 in the shape of the circular ring.

Further; the oil paths 230, . . . are constituted by a linear shape in parallel with axial directions of the first shaft portion 106 and the second shaft portion 104 of the outer ring, and the flow outlets 232, . . . of the oil paths 230, . . . are arranged at a surrounding of the first shaft portion 106. That is, the flow outlets 232, . . . are arranged on an inner side of the balls 26, 26 of the thrust ball bearing 24 formed by the outer ring 28 and the like and the lubricant is supplied to the thrust ball bearing 24.

Further, the second shaft portion 104 of the outer ring 28 is arranged in a state of being penetrated through the oval hole 102 of the support plate portion 16 as the through hole, as shown by FIG. 7, a stop ring 105 is attached to a rear end portion of the second shaft portion 104 projected rearward from the support plate portion 16 of the second shaft portion 104, thereby, the outer ring 28 is attached to the support plate portion 16 movably along a length direction (direction perpendicular to the second axis direction) of the oval hole 102. Further, at this occasion, it is necessary to adjust a position of the stop ring 105 such that oil is not leaked to between the rear face of the outer ring 28 and the oil guide member 210.

According to the toroidal type continuously variable transmission of the third embodiment as described above, even when the oval hole 102 is constituted by the through hole in the toroidal type continuously variable transmission of the first embodiment, lubricant can be prevented from flowing out from the oval hole 102.

That is, the lubricant flows out from the flow outlet 222 formed at the inner side face of the support plate portion 16 of the oil path 220 of the trunnion 15 to the through hole 213 of the oil guide member 210, and the lubricant flows out from the through hole 213 to the first oil groove 212 in the shape of the circular ring on the side of the front face of the oil guide member 210. Further, the lubricant is not leaked as described above but flows from the first oil groove 212 to the second oil groove 250 at the rear face of the outer ring 28, and is supplied from the second oil groove 250 to the thrust ball bearing 24 as the bearing of the power roller 11 via the oil path 230 of the outer ring 28.

Further, by attaching the oil guide member 210 to the support plate portion 16 prior to the bearing 100, the oil guide member 210 can be used as the member for positioning to attach and guiding to attach the bearing 100, further, can be used as the portion of the member for restricting movement of the bearing 100 when the bearing 100 is used.

The above-described function can be realized by attaching the oil guide member 210 to the trunnion 15 and therefore, it is not necessary to provide a complicated structure at the trunnion 15 and the above-described function can be realized at low cost without increasing fabricating cost of the trunnion 15.

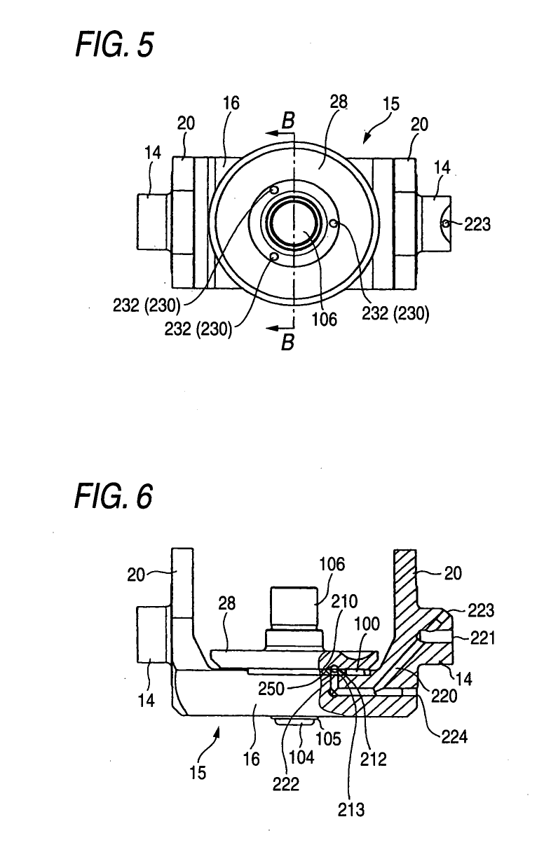

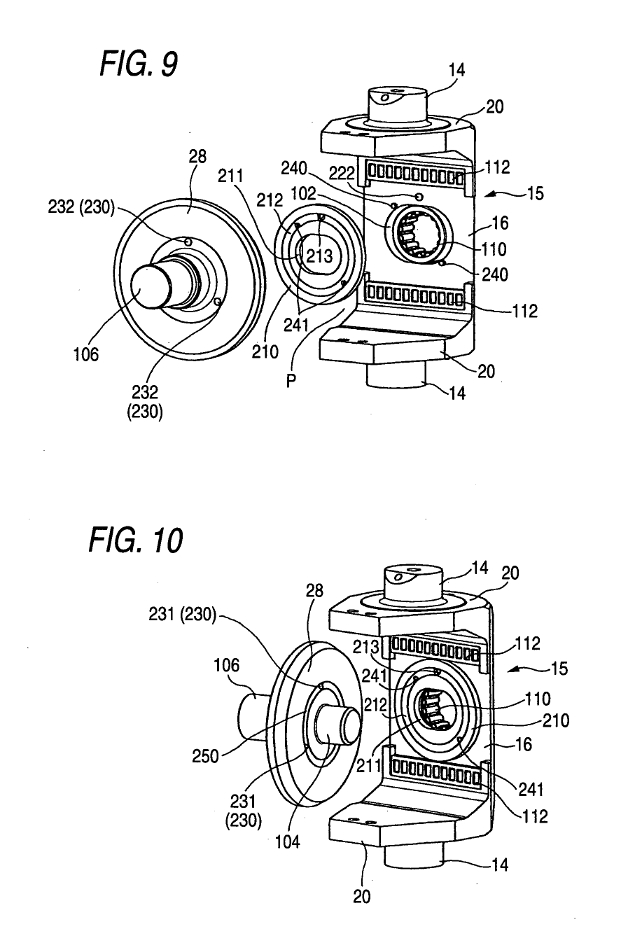

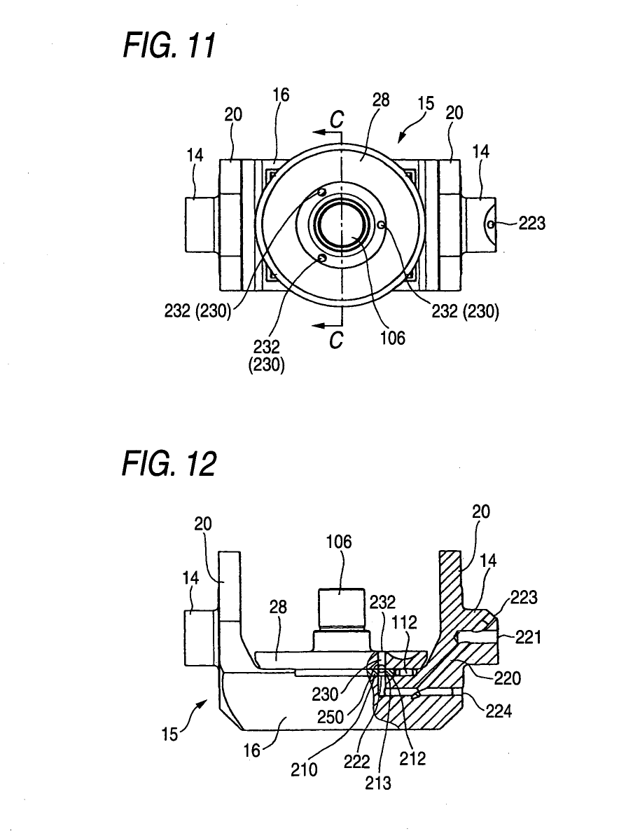

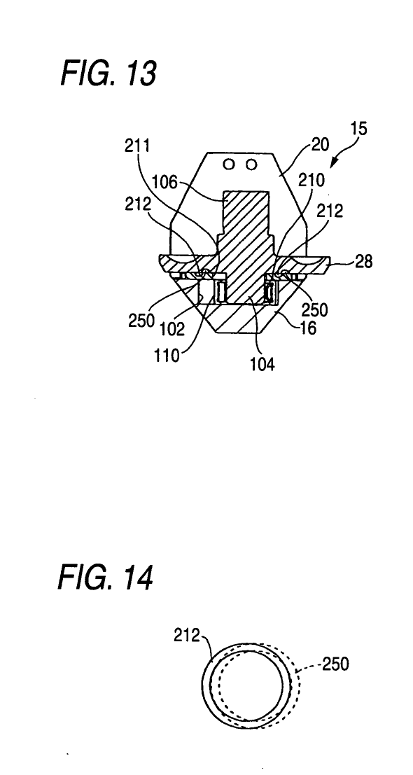

FIG. 9 through FIG. 14 show a fourth embodiment of the invention. Further, a toroidal type continuously variable transmission of the fourth embodiment is constituted by adding a lubricant supply structure for supplying the lubricant to the thrust ball bearing 24 of the power roller 11 to the toroidal type continuously variable transmission according to the second embodiment shown in FIG. 2 similar to the third embodiment and in the following, only a portion different from the second embodiment and the third embodiment is referred to, the other portion are attached with notations the same as those of FIG. 2 through FIG. 8 and a concise explanation will be given of the portions. Further, in the third embodiment, FIG. 9 corresponds to FIG. 3, FIG. 10 corresponds to FIG. 4, FIG. 11 corresponds to FIG. 5, FIG. 12 corresponds to FIG. 6, FIG. 13 corresponds to FIG. 7 and FIG. 14 corresponds to FIG. 8.

Further, a main difference between the third embodiment and the fourth embodiment resides in that whereas the bearing arranged between the outer ring 28 and the support plate portion 16 is the thrust needle bearing (bearing 100) in the shape of the circular ring in the third embodiment according to the fourth embodiment, the bearing is constituted by the pair of thrust needle bearings in the linear shape, and whereas the oval hole 102 of the support plate portion 16 is constituted by the through hole according to the third embodiment, the oval hole 102 is constituted by a closed hole according to the fourth embodiment. Further, whereas the second shaft portion 104 of the outer ring 28 is inserted into the oval hole 102 as it is according to the third embodiment, the radial needle bearing 100 is interposed between the second shaft portion 104 and the oval hole 102 according to the fourth embodiment.

According to the fourth embodiment, similar to the third embodiment, the oil guide member 210 is provided between the support plate portion 16 constituting the main body portion of the trunnion 15 and the outer ring 28. The oil guide member 210 is provided with a structure similar to that of the third embodiment.

However, whereas according to the third embodiment, the oval hole 211 of the oil guide member 210 is provided with the shape similar to that of the oval hole 102 of the support plate portion 16, according to the fourth embodiment, the oval hole 102 of the support plate portion 16 is inserted with the radial needle bearing 110 inserted with the second shaft portion 104 of the outer ring 28, only the second shaft portion 104 is penetrated through the oval hole 211 of the oil guide member 210 and therefore, the oval hole 211 of the oil guide member is constituted by a size one size smaller than that of the oval hole 102 of the support plate portion 16.

Further, whereas according to the third embodiment, the oil guide member 210 is arranged on the inner side of the bearing 100 which is the thrust needle bearing in the shape of the circular ring, according to the fourth embodiment, the oil guide member 210 is arranged between (inner sides of) the bearings 112, 112 which are the pair of thrust needle bearings in the linear shape attached to the support plate portion 16 such that an outer periphery thereof is substantially brought into contact with the bearings 112, 112.

That is, a diameter of the oil guide member 210 is constituted to be substantially equal to an interval between the pair of bearings 112, 112.

The other constitution is similar to that of the third embodiment, operation and effect and similar to those of the third embodiment can be achieved.

That is, according to the toroidal type continuously variable transmission of the fourth embodiment, in the toroidal type continuously variable transmission of the second embodiment, the lubricant can be prevented from flowing out from clearances produced between the pair of bearings 112, 112 and left and right sides between the rear face of the outer ring 28 and the inner side face of the support plate portion 16.

That is, the lubricant flows out from the flow outlet 222 formed-at the inner side face of the support plate portion 16 of the oil path 220 of the trunnion 15 to the through hole 213 of the oil guide member 210, and the lubricant flows out from the through hole 213 to the first oil groove 212 in the shape of the circular ring on the side of the front face of the oil guide member 210. Further, the lubricant does not leak as described above but flows in from the first oil groove 212 to the second oil groove 250 at the rear face of the outer ring 28 and is supplied from the second oil groove 250 to the thrust ball bearing 24 as the bearing of the power roller 11 via the oil path 230 of the outer ring 28.

Further, when in assembling, the oil guide member 210 is positioned as described above and attached to the trunnion 15 prior to the bearing 100, in attaching the bearings 112, 112 to the trunnion 15, attachment of the bearings 112, 112 can be guided by the oil guide member 210, and the oil guide member 210 can be utilized as a portion of a member positioning the bearings 112, 112, holding the bearings 112, 112 such that the bearings 112, 112 are not moved when the bearings 112, 112 are attached and restricting movement of the bearings 112, 112 when the bearings 112, 112 are used. Thereby, fabrication cost of the trunnion 15 can be reduced by omitting a portion of a guide member for the bearings formed at surroundings of the pair of bearings 112, 112 in the linear shape of the support plate portion 16.

Further, although according to the second embodiment and the fourth embodiment, as shown by FIG. 2, FIG. 9 and FIG. 10, in the support plate portion 16, at surroundings of the bearings 112, 112, a member for restricting movement of the bearings 112, 112 is not illustrated on inner sides of the pair of bearings 112, 112 to constitute a shape of omitting the member, by attaching the oil guide member 210 to the support plate portion 16, movement of the pair of bearings 112, 112 in directions of being proximate to each other (inner sides) is restricted to bring about a state of reducing fabrication cost of the trunnion 15 by partially omitting a structure of the support plate portion 16.

The above-described function can be realized by attaching the oil guide member 210 to the trunnion 15 and therefore, it is not necessary to provide a complicated structure to the trunnion 15 and the above-described function can be realized at low cost without increasing fabrication cost of the trunnion 15.

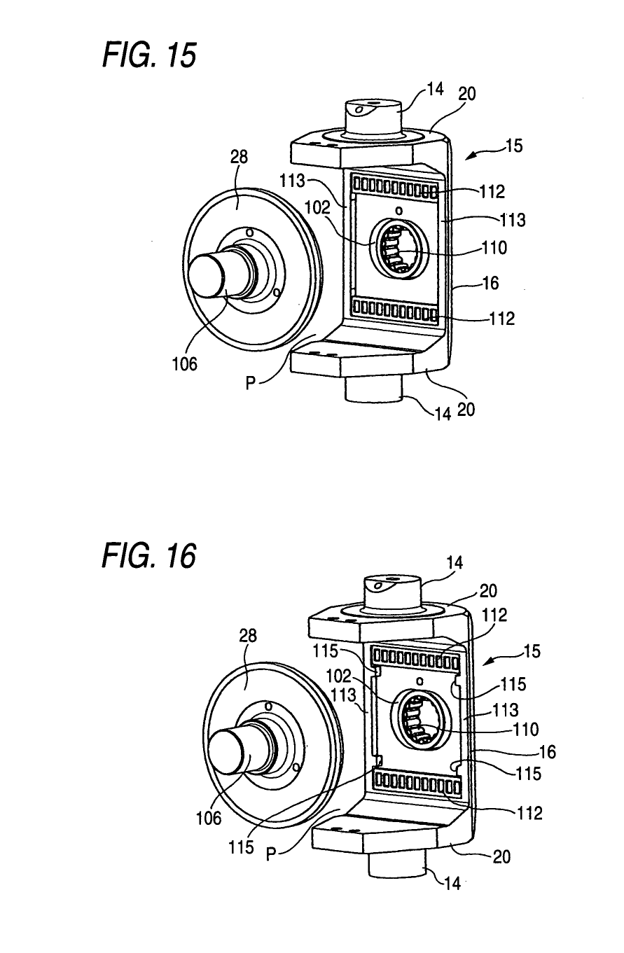

Further, as shown by FIG. 15, in the toroidal type continuously variable transmission of the second embodiment, by forming ribs 113, 113 having a thickness substantially the same as that of the bearings 112, 112 from the bearing 112 from one side over to the bearing 112 on other side at left and right side edge portions of the inner side face of the support plate portion 16, clearances produced on left and right sides between the pair of bearings 112, 112 and between the rear face of the outer ring 28 and the inner side of the support plate portion 16 can be closed and the lubricant can be prevented from flowing out from the clearances.

Further, as shown by FIG. 16, by forming projected portions 115, . . . to portions constituting inner sides of the pair of bearings 112, 112 at the ribs 113, 113 along side faces of the bearings 112, 112, that is, by forming the projected portions 115, . . . at positions along side edges of the pair of bearings 112, 112 of the support plate portion 16 opposed to each other to be substantially brought into contact with the side edges, movement of the bearings 112, 112 can completely be restricted.

However, by forming the ribs 113, 113 and the projected portions 115, . . . , portions of the trunnion 15 to be worked are increased, fabrication cost of the trunnion 15 is increased and in view of simplifying a structure of the trunnion 15, it is preferable to use the oil guide member 210 as shown by the third and the fourth embodiments.

The invention is applicable to various toroidal type continuously variable transmissions of a single cavity type, a double cavity type or the like.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A toroidal type continuously variable transmission comprising;
an input side disk and an output side disk arranged concentrically with a first axis and opposed to each other;
a power roller held between-the input and output side disks;
a trunnion disposed so as to swing around a second axis which is twisted to the first axis; and
an outer ring contained in a pocket portion provided at a center portion of the trunnion in a direction of the second axis,
wherein the trunnion includes.
a main body portion extended substantially in parallel with the second axis;
a pair of bent wall portions extended from both end portions of the main body portion;
pivot shafts extended to outer sides from both of the bent wall portions along with the second axis; and
an oval hole, of which longitudinal axis extends in a direction perpendicular to the second axis, formed on a center portion of the main body portion in a direction of the second axis,
wherein a bearing for movably supporting the outer ring in the direction perpendicular to the second axis is provided between the main body portion of the trunnion and the outer ring,
wherein the outer ring includes:
a first shaft portion for rotatably supporting the power roller; and,
a second shaft portion arranged substantially concentrically with the first shaft portion and movably supported by the oval hole of the trunnion along a direction perpendicular to the second axis, and
wherein tangential forces generated between the power roller and both of the input and output side disks are supported on both of the second shaft portion and the trunnion.

2. The toroidal type continuously variable transmission according to claim 1, wherein the bearing is a thrust needle bearing in a shape of a circular ring, and
the bearing is formed substantially concentrically with a surrounding of the oval hole for supporting a force in a thrust direction.

3. A toroidal type continuously variable transmission, comprising:
an input side disk and an output side disk arranged concentrically with a first axis and opposed to each other;
a power roller held between the input and output side disks;
a trunnion disposed so as to swing around a second axis which is twisted to the first axis; and
an outer ring contained in a pocket portion provided at a center portion of the trunnion in a direction of the second axis,
wherein the trunnion includes:
a main body portion extended substantially in parallel with the second axis;
a pair of bent wall portions extended from both end portions of the main body portion;
pivot shafts extended to outer sides from the bent wall portions along with the second axis; and
an oval hole, of which longitudinal axis extends in a direction perpendicular to the second axis, formed on a center portion of the main body portion in a direction of the second axis,
wherein a bearing for movably supporting the outer ring in the direction perpendicular to the second axis is provided between the main body portion of the trunnion and the outer ring,
wherein the outer ring includes:
a first shaft portion for rotatably supporting the power roller; and
a second shaft portion arranged substantially concentrically with the first shaft portion and supported by the oval hole of the trunnion movably via a radial bearing along a direction perpendicular to the second axis, and
wherein tangential forces generated between the power roller and both of the input and output side disks are supported on the second shaft portion, the radial bearing and the trunnion.

4. The toroidal type continuously variable transmission according to claim 3, wherein the bearing comprises:
a pair of thrust needle bearings supporting a force in a thrust direction and extended linearly along the direction perpendicular to the second axis,
wherein and the thrust needle bearings is opposed to each other across the oval hole.

5. The toroidal type continuously variable transmission according to claim 1, further comprising:
an substantially ring-like oil guide member provided between the main body portion of the trunnion and the outer ring and the oil guide member provided on an inner side of the bearing so as to surround the oval hole,
wherein a first oil groove is formed on a face of the oil guide member which abuts with the outer ring,
the first oil groove communicates with a trunnion side oil path for a lubricant formed on the trunnion and is ring shape which is concentric with the oval hole, and
wherein a second oil groove is formed on a face of the outer ring which abuts with the oil guide member,
the second oil groove opposes to the first oil groove and communicates with an outer ring side oil path for lubricant formed on the outer ring,
the second oil groove of which diameter is substantially the same as that of the first oil groove and is arranged concentric with the second shaft portion.

6. The toroidal type continuously variable transmission according to claim 3, further comprising:
an substantially ring-like oil guide member provided between the main body portion of the trunnion and the outer ring and the oil guide member provided on an inner side of the bearing so as to surround the oval hole,
wherein a first oil groove is formed on a face of the oil guide member which abuts with the outer ring,
the first oil groove communicates with a trunnion side oil path for a lubricant formed on the trunnion and is ring shape which is concentric with the oval hole, and
wherein a second oil groove is formed on a face of the outer ring which abuts with the oil guide member,
the second oil groove opposes to the first oil groove and communicates with an outer ring side oil path for lubricant formed on the outer ring,
the second oil groove of which diameter is substantially the same as that of the first oil groove and is arranged concentric with the second shaft portion.
